(19) United States
(12) Patent Application Publication
(10) Pub. No.: US 2025/0036967 A1
(43) Pub. Date: Jan. 30, 2025

(54) METHOD FOR TRAINING A MACHINE LEARNING MODEL TO CLASSIFY SENSOR DATA

(71) Applicant: Robert Bosch GmbH, Stuttgart (DE)

(72) Inventors: Csaba Domokos, Simmozheim (DE); Frank Schmidt, Leonberg (DE)

(21) Appl. No.: 18/773,652

(22) Filed: Jul. 16, 2024

(30) Foreign Application Priority Data
Jul. 27, 2023 (EP) 23188222.6

(51) Int. Cl. G06N 5/01; G06N 7/01

(52) U.S. Cl. CPC G06N 5/01; G06N 7/01

(57) ABSTRACT

A method for training a machine learning model to classify sensor data. The method includes, for each training sensor data element of a plurality of training sensor data elements, processing a relevant input vector through a sequence of decisions of the machine learning model, wherein, for each decision, the scalar product of the input vector with a relevant parameter vector is formed and the result of the decision depends on whether the scalar product is less or greater than a specified relevant parameter; ascertaining a loss for the training data element; and adjusting the machine learning model to reduce a total loss, which includes the losses ascertained for the sensor data training data elements, wherein the parameter vector for each decision of the machine learning model is adjusted within a continuous value range.

### FIELD

The present invention relates to a method for training a machine learning model to classify sensor data.

### BACKGROUND INFORMATION

Object detection (in particular in images) is a common task in the context of autonomously controlling robotic devices, such as robotic arms and autonomous vehicles. For example, a controller for a robotic arm should be able to recognize an object to be picked up by the robotic arm (e.g., among multiple different objects), and an autonomous vehicle must be able to recognize other vehicles, pedestrians and stationary obstacles as such.

It may be desirable that such object detection (in particular a classification as to which object is “contained” in sensor data, i.e., represented by the sensor data) is carried out in a device with low data processing resources, e.g., an intelligent (i.e., “smart”) sensor. Due to the limited data processing resources (computing power and memory), the use of a relatively simple machine learning model for object detection, such as a decision tree, is desirable in such a case. However, in a decision tree, a component of an input vector (e.g., a vector of features extracted from sensor data) is typically selected at each node, which results in the decision tree not being differentiable with respect to its parameters (since the selection function is not differentiable) and gradient-based training methods therefore not being possible. This makes training such a machine learning model inefficient.

Approaches that make efficient training for decision tree-based machine learning models possible are therefore desirable.

### SUMMARY

According to various embodiments of the present invention, a method for training a machine learning model to classify sensor data is provided, comprising:
For each of the training sensor data elements of a plurality of training sensor data elements,
   Representing the training sensor data element as an input vector;
   Processing the input vector through a sequence of decisions of the machine learning model (i.e., the machine learning model contains at least one decision tree), wherein, for each decision, the scalar product of the input vector with a relevant parameter vector is formed and the result of the decision depends on whether the scalar product is less or greater than a specified relevant parameter;
   Ascertaining, depending on the results of the sequence of decisions, for each of multiple classes, a relevant class membership probability for the training sensor data element;
   Ascertaining a loss of the class membership probability, ascertained for the training data element, in comparison to a ground truth for the class membership of the sensor data training data element;
Adjusting the machine learning model in order to reduce a total loss, which includes the losses ascertained for the sensor data training data elements, wherein the parameter vector for each decision of the machine learning model is adjusted within a continuous value range.

The method described above makes gradient-based training of a (generalized and therefore differentiable) decision tree possible. This, for example, makes training that can be adjusted to new data possible, and the training can be integrated into differentiable frameworks, such as those used for deep learning. In addition, the decision tree formulated in this way with differential approaches is suitable for robustness and explainability analysis.

Various exemplary embodiments of the present invention are specified below.
Exemplary embodiment 1 is a method for training a machine learning model, as described above.
Exemplary embodiment 2 is a method according to exemplary embodiment 1, wherein the continuous value range is the N-dimensional unit ball with respect to the sum norm.

This achieves that the parameter vectors develop during training such that they are ultimately (each) sparsely populated or that a classic decision tree is even produced in which there is only one 1 in each parameter vector (all other entries must then be 0 due to the form of the value range).
Exemplary embodiment 3 is a method according to exemplary embodiment 1 or 2, comprising, for each of the sensor data training data elements,
   For each sequence of multiple sequences of decisions of the machine learning model (i.e., multiple decision trees of the machine learning model),
      Processing the relevant input vector through the sequence of decisions, wherein, for each decision, the scalar product of the input vector with a relevant parameter vector (per decision and per decision tree) is formed and the result of the decision depends on whether the scalar product is less or greater than a specified relevant parameter (per decision and per decision tree),
      Ascertaining, depending on the results of the relevant sequence of decisions, for each of multiple classes, a relevant class membership probability for the training sensor data element;
      Ascertaining, for each class, a combined membership probability for the class by summing the membership probabilities ascertained for the sequences of decisions for the class,
      Ascertaining a loss of the combined class membership probability, ascertained for the training data element, in comparison to the ground truth for the class membership of the sensor data training data element; and
   Adjusting the machine learning model in order to reduce a total loss, which includes the losses ascertained for the sensor data training data elements, wherein the parameter vector(s) for each decision of the machine learning model (and thus for each of the decision trees) is adjusted within the continuous value range.

By using multiple decision trees, the machine learning model is more flexible and can learn complex classification tasks.
Exemplary embodiment 4 is a method according to one of exemplary embodiments 1 to 3, wherein, for each decision, the result of the decision is calculated, which is zero if the scalar product is less than the specified relevant parameter and is not equal to zero otherwise (e.g., greater than zero, but this can, of course, also be implemented with negative values).

This makes it possible to simply ascertain the decision results and (after final normalization) to simply ascertain the class membership probabilities.
Exemplary embodiment 5 is a method for controlling a robotic device, comprising
   Training a machine learning model by means of the method according to one of exemplary embodiments 1 to 4,
   Capturing sensor data relating to an environment of the robotic device;
   Classifying an object, represented by the sensor data, by classifying the sensor data by means of the trained machine learning model; and
   Controlling the robotic device according to the classification of the object.
Exemplary embodiment 6 is a data processing device configured to carry out a method according to one of exemplary embodiments 1 to 5.
Exemplary embodiment 7 is a computer program comprising commands which, when executed by a processor, cause the processor to carry out a method according to one of exemplary embodiments 1 to 5.
Exemplary embodiment 8 is a computer-readable medium storing commands which, when executed by a processor, cause the processor to carry out a method according to one of exemplary embodiments 1 to 5.

In the figures, similar reference signs generally refer to the same parts throughout the various views. The figures are not necessarily true to scale, with emphasis instead generally being placed on the representation of the principles of the present invention. In the following description, various aspects of the present invention are described with reference to the figures.

### BRIEF DESCRIPTION OF THE DRAWINGS

FIG. 1 shows a vehicle, according to an example embodiment of the present invention.

FIG. 2 illustrates a decision tree, according to an example embodiment of the present invention.

FIG. 3 shows a flowchart representing a method for training a machine learning model to classify sensor data, according to an embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects of the present invention.

Various examples are described in more detail below.

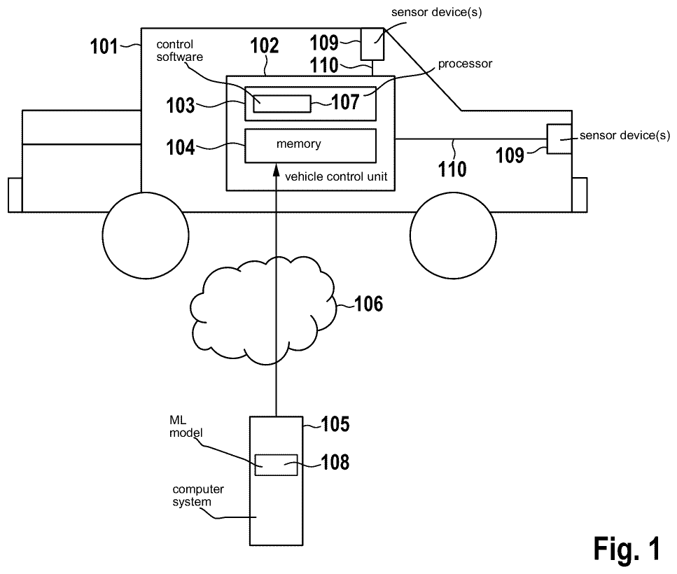

FIG. 1 shows a vehicle 101.

In the example of FIG. 1, a vehicle 101, for example a passenger car or truck, is provided with a vehicle control unit (also referred to as an electronic control unit (ECU), e.g., a control device) 102.

The vehicle control unit 102 comprises data processing components, e.g., a processor (e.g., a CPU (central unit)) 103 and a memory 104 for storing control software 107, according to which the vehicle control unit 102 operates, and data, which are processed by the processor 103. The processor 103 executes the control software 107.

For example, the stored control software (computer program) comprises instructions which, when executed by the processor, cause the processor 103 to perform driver assistance functions (i.e., the function of an ADAS (advanced driver assistance system)) or even to control the vehicle autonomously (AD (autonomous driving)).

The control software 107 is, for example, transmitted to the vehicle 101 from a computer system 105, for example via a communication network 106 (or by means of a storage medium such as a memory card). This can also take place in operation (or at least when the vehicle 101 is with the user) since the control software 107 is updated over time to new versions, for example.

The control software 107 ascertains control actions for the vehicle (such as steering actions, braking actions, etc.) from input data that are available to it and that contain information about the environment or from which it derives information about the environment (for example, by detecting other road users, e.g., other vehicles). These input data are, for example, sensor data from one or more sensor devices 109, for example from a camera of the vehicle 101, which are connected to the vehicle control unit 102 via a communication system 110 (e.g., a vehicle bus system such as CAN (controller area network)).

For processing the sensor data, a machine learning model 108 may be provided, which is trained on the basis of training data, in this example by the computer system 105. The computer system 105 thus implements an ML training algorithm for training one (or more) ML model(s) 108.

For example, the ML model is an ML model for object recognition (e.g., other vehicles, etc.), in particular a classification (e.g., a classification of a camera image or an area in a camera image as to what is shown in the image or image area).

By processing the raw sensor data (such as camera images) in this way, “intelligent” sensors are created, which provide more information than just raw sensor data, such as classification output for downstream tasks (e.g., controlling the vehicle 100). For this purpose, it may be desirable to implement the machine learning model 108 directly in a relevant sensor device 109 (e.g., it is loaded into the sensor device 109 by the control unit 102) so that the sensor device 109 implements an intelligent sensor in this sense.

However, since the computing capabilities of such a sensor device 109 are typically rather limited, it may be necessary for the machine learning model 108 to have a relatively low complexity. One possibility in the case of a classification task is to combine decision trees to form a collection of decision trees (to form a “forest,” e.g., a random forest or a boosted tree), in order to assign a certain probability to each class of a specified set of classes (e.g., pedestrian, vehicle, traffic sign). Although this approach works well in practice, it requires that the sensor device 109 is a standalone system. In order to integrate the sensor device 109 into a larger system (e.g., with multiple sensor devices 109, which are to work together), it is desirable to retrain the collection of decision trees, typically on the basis of a back-propagated loss.

However, since classic decision trees are not differentiable, this cannot be achieved with a gradient-based approach. An embodiment that makes training by means of a gradient-based approach possible is therefore described below. According to various embodiments, this is done, illustratively speaking, by using a more general formulation of a collection of decision trees (specifically of a single decision tree). Note: A collection of trees is referred to as a “forest” below. This is not to be confused with a random forest, which is a specific combination of trees on the basis of majority decisions.

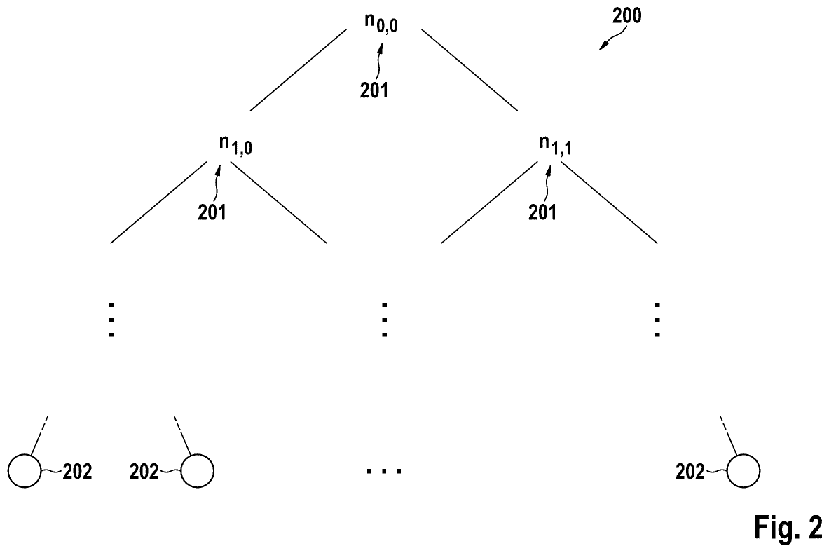

FIG. 2 illustrates a decision tree 200.

A decision tree is a binary tree in which, at each node n, a decision 201 is made as to whether to follow the left or the right branch at this node. Mathematically, the decision can be described as a function dₙ:R^{N}→R, wherein x∈R^{N} is the feature input vector. The decision to enter the relevant left branch is then determined by [dₙ(x)≤0]. In the example of FIG. 1 (and in the following examples), the nodes n are indexed by two numbers: The first number is the level of the tree l (l=0, . . . , [symbol] ), the second number is the number of the relevant node (starting at zero within the level). At the very end of the decision tree is a plurality of 2 [symbol] leaves 202. Each leaf 202 (index j) is assigned a vector qⱼ. This vector contains a contribution to the class probability (i.e., class soft value) for each class. For example, if the decision tree comes to a certain leaf j when processing an input vector x∈R^{N} (which was derived, for example, from a camera image or is a vector representation of other sensor data or features thereof), this, for example, provides information such as “probability for pedestrians 10%, for cyclists 15%, for traffic signs 70%” through the vector qⱼ). By combining (normalized summation) these outputs from multiple decision trees, an output vector F (x) with a class probability for each class can then be generated.

In a classic decision tree, decision functions of the following form are used:

$${d}_{n} ( x ) = {x}_{i} - b \qquad ( 1 )$$

This means that a component xᵢ of the input vector x∈R^{N} (i.e., for example, a certain feature) is selected and compared with a threshold value b∈R. Training such a decision tree includes training the pair (i,) (for each node), and conclusions can be generated very quickly, i.e., the inference is very fast since it requires only one if clause per decision node in a computer program. However, the discrete value i (i.e., the operation of selecting a component of x) makes this approach non-differentiable so that training with back propagation is not possible.

Various embodiments to make training with back propagation possible are based on the use of the function

$${d}_{n} ( x ) = 〈 x , s 〉 - b \qquad ( 2 )$$

for the decisions.

Here, b∈R is a continuous threshold, as above, and s∈S with

$$S = \{ y ∈ {R}^{N} \vert {\sum }_{i = 1}^{N} \vert {y}_{i} \vert \leq 1 \} , \qquad ( 3 )$$

i.e., from the N-dimensional unit ball with respect to the sum norm (i.e., l1 norm).

Not only are the decisions at each node differentiable in this approach, but the approach also contains the original feature selection approach: Indeed, dₙ(x)=xᵢ−b can be simulated by choosing s as the i-th unit vector. Thus, training the decision tree with the decisions according to (2) can lead to a “classic” decision tree with a decision tree according to (1).

In particular, the sparsity of s can be rewarded in the training so that the additional computational effort (which could in principle occur in the case of decisions according to (2)) (in the inference) is limited. This can, for example, take place in that a trainable variable s′∈R^{N} is trained in the training and s=πs(s′) is set (i.e., for ascertaining s, the vector s′ is projected onto the set of (3), e.g., in the sense of the l2 projection (i.e., the projection of s′ onto S is the nearest point on S to s′ in the sense of the Euclidean distance).

The decision dn according to (2) can be translated into a layer Lₗ:R²^{^{l}}×Rⁿ→ for each level l of the decision tree. This layer calculates

$${{L}_{ℓ} ( {p}_{1} , … , {p}_{2} ℓ , x )}_{2 k - 1 , 2 k} = ( {p}_{k} \cdot ϕ ( {d}_{{n}_{k}} ( x ) ) ; {p}_{k \cdot } ϕ ( - {d}_{{n}_{k}} ( x ) ) ) \qquad ( 4 )$$

Here, ϕ is an activation function, such as ReLU, i.e., ϕ(x)=[x]₊, or possibly another activation function.

As an example, let's consider a decision tree with two (decision) levels, i.e., a root n_{0,0} and two inner nodes n_{1,0} and n_{1,1} (i.e., nodes between root and leaves).

Given a data point (i.e., input vector) x∈R^{N}, the following is calculated

$$\begin{matrix}1. {p}^{1} = ( {p}_{1}^{1} , {p}_{2}^{1} ) = {L}_{0} ( 1 , x ) = ( {[ {d}_{{n}_{0 , 0}} ( x ) ]}_{+} , {[ {d}_{{n}_{0 , 0}} ( x ) ]}_{-} ) \\ \begin{matrix}2. {p}^{2} = {L}_{1} ( {p}^{1} , x ) = ( {[ {p}_{1}^{1} \cdot {d}_{{n}_{1 , 0}} ( x ) ]}_{+} , {[ {p}_{1}^{1} \cdot {d}_{{n}_{1 , 0}} ( x ) ]}_{-} , \\ {{[ {p}_{2}^{1} \cdot {d}_{{n}_{1 , 1}} ( x ) ]}_{+} , {p}_{2}^{1} \cdot {d}_{{n}_{1 , 1}} ( x ) ]}_{-} )\end{matrix}\end{matrix}$$

The vector p² contains four values, only one of which is not equal to zero. The discrete path within the decision tree can thus be simulated in a continuous sense. In the approach described, each discrete decision in a decision tree is thus replaced by a continuous counterpart.

In the form of an algorithm in pseudo-code, the output of a decision tree with depth [symbol] for an input vector x∈R^{N} is calculated as follows:
1. Set i=0, p=1.
2. Calculate p-Lᵢ(p,x) according to (4)
3. Set i=i+1 and go back to 2 if i< [symbol] .
4. Calculate

$$p = \frac{p}{{\sum }_{i = 1}^{{2}^{ℒ}} {p}_{i}}$$

5. Return T(x):=Σᵢ₌₁²^{^{e}}pᵢ·qⱼ

The following parameters are trainable:
For each layer i< [symbol] , sᵢ and bᵢ.
The class probabilities q₁, . . . q₂ [symbol] .

For example, for a batch of training inputs x∈R^{N}, a loss can in each case be calculated (e.g., cross entropy loss with respect to ground truth labels) and the trainable parameters can be adjusted to reduce the loss.

When using a forest (formed from a convex combination of such differentiable decision trees), there are also mixing parameters θₖ≥0, and the classification result is F(x)=Σθₖ·Tₖ(x), wherein Σθₖ=1 and Tₖ(x) is the result of the k-th tree (step 5 in the above algorithm).

In this case, the trainable parameters per decision tree (as given above) as well as the mixing parameters for reducing the loss (of F(x) in comparison to a ground truth) can be trained in the training.

For a classification problem in a fully supervised environment, the cross entropy loss can be used as mentioned above. As explained above, the output of a decision tree or forest is a probability per class so the cross entropy loss is well suited.

In order to simplify training, the ReLU function can be replaced by a leaky ReLU function, whose leakiness can be reduced during the training time.

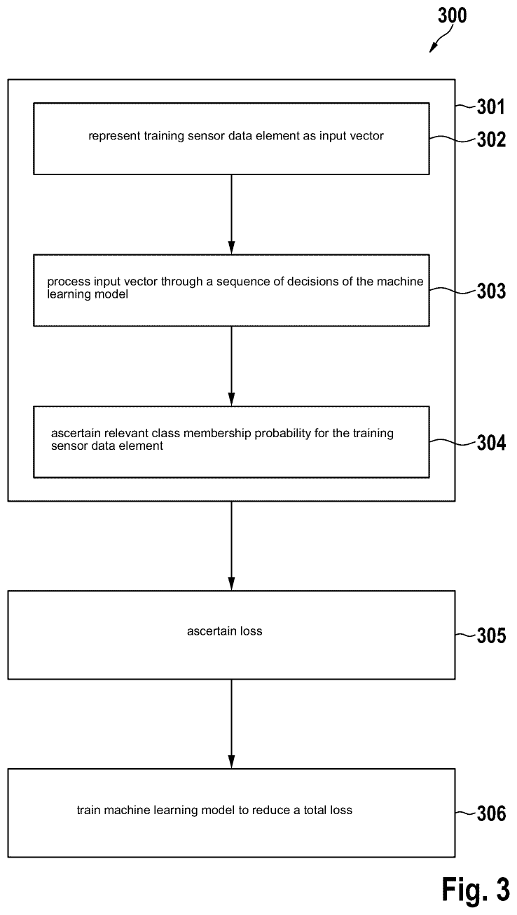

In summary, according to various embodiments, a method as shown in FIG. 3 is provided.

FIG. 3 shows a flowchart 300 representing a method for training a machine learning model to classify sensor data, according to an embodiment.

In 301, for each of the training sensor data elements of a plurality of training sensor data elements,
In 302, the training sensor data element is represented as an input vector (denoted by x in the exemplary embodiments) (i.e., a corresponding input vector is generated, for example by feature extraction from the sensor data of the training sensor data element)
In 303, the input vector is processed through a sequence of decisions of the machine learning model (i.e., the machine learning model contains at least one decision tree), wherein, for each decision, the scalar product of the input vector (x) with a relevant parameter vector (denoted by s in the exemplary embodiments) is formed and the result of the decision depends on whether the scalar product is less or greater than a specified relevant parameter (denoted by b in the exemplary embodiments) (accordingly, the result of the decision is, for example, 0 or greater than zero),
In 304, depending on the results of the sequence of decisions, for each of multiple classes, a relevant class membership probability for the training sensor data element is ascertained (depending on the leaf reached (to which the membership probabilities are assigned)); and
In 305, a loss of the class membership probability, ascertained for the training data element, in comparison to a ground truth for the class membership of the sensor data training data element is ascertained.

In 306, the machine learning model is used to reduce a total loss, which includes the losses ascertained for the sensor data training data elements, wherein the parameter vector(s) for each decision of the machine learning model is adjusted within a continuous value range (i.e., parameter values of the machine learning model, in particular s (and also b or the mixing parameters θₖ as in the example above), are adjusted in a direction in which the loss is reduced, i.e., according to a gradient of the loss, typically by using a back propagation).

The method of FIG. 3 may be carried out by one or more computers comprising one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit.

The method is therefore in particular computer-implemented according to various embodiments.

Various embodiments may receive and use image data from various sensors (which may provide output data in image form), such as individual images, video, radar, LiDAR, ultrasound, motion, thermal imaging, etc. Sensor data can be measured or also simulated for periods of time (e.g., in order to generate training data elements).

These sensor data can in particular be classified, e.g., in order to detect the presence of objects represented in the sensor data (e.g., traffic signs, the roadway, pedestrians and other vehicles in the case of use in a vehicle). In particular, the approach of FIG. 4 can be integrated into various frameworks in which new classes occur. In this way, the approach of FIG. 4 can be used with various AI-controlled perception systems, such as in robotics and self-driving cars.

The approach of FIG. 4 is generally used, for example, to generate a control signal for a robotic device. The term “robotic device” may be understood to refer to any technical system (comprising a mechanical part whose movement is controlled), such as a computer-controlled machine, a vehicle, a household appliance, a power tool, a manufacturing machine, a personal assistant or an access control system. A control rule for the technical system is learned, and the technical system is then controlled accordingly. However, the approach can also be used in systems that reproduce information, for example in a surveillance system (e.g., people are detected) or a medical (image processing) system.

1-8. (canceled)

9. A method for training a machine learning model to classify sensor data, comprising the following steps:
for each training sensor data element of a plurality of training sensor data elements:
representing the training sensor data element as an input vector,
processing the input vector through a sequence of decisions of the machine learning model, wherein, for each decision, the scalar product of the input vector with a relevant parameter vector is formed and a result of the decision depends on whether the scalar product is less or greater than a specified relevant parameter,
ascertaining, depending on the results of the sequence of decisions, for each of multiple classes, a relevant class membership probability for the training sensor data element, and
ascertaining a loss of the class membership probability, ascertained for the training data element, in comparison to a ground truth for class membership of the sensor data training data element;
adjusting the machine learning model in order to reduce a total loss, which includes the losses ascertained for the sensor data training data elements, wherein the parameter vector for each decision of the machine learning model is adjusted within a continuous value range.

10. The method according to claim 9, wherein the continuous value range is an N-dimensional unit ball with respect to a sum norm.

11. The method according to claim 9, further comprising:
for each of the sensor data training data elements, for each sequence of multiple sequences of decisions of the machine learning model:
processing the input vector through the sequence of decisions, wherein, for each decision, the scalar product of the input vector with the relevant parameter vector is formed and the result of the decision depends on whether the scalar product is less or greater than a specified relevant parameter,
ascertaining, depending on the results of the sequence of decisions, for each of multiple classes, a relevant class membership probability for the training sensor data element;
ascertaining, for each class, a combined membership probability for the class by summing the membership probabilities ascertained for the sequences of decisions for the class,
ascertaining a loss of the combined class membership probability, ascertained for the training data element, in comparison to the ground truth for the class membership of the sensor data training data element;
adjusting the machine learning model in order to reduce the total loss, which includes the losses ascertained for the sensor data training data elements, wherein the parameter vector for each decision of the machine learning model is adjusted within the continuous value range.

12. The method according to claim 9, wherein, for each decision, the result of the decision is calculated, which is zero when the scalar product is less than the specified relevant parameter and is not equal to zero otherwise.

13. A method for controlling a robotic device, comprising the following steps:
training a machine learning model by:
for each training sensor data element of a plurality of training sensor data elements:
representing the training sensor data element as an input vector,
processing the input vector through a sequence of decisions of the machine learning model, wherein, for each decision, the scalar product of the input vector with a relevant parameter vector is formed and a result of the decision depends on whether the scalar product is less or greater than a specified relevant parameter,
ascertaining, depending on the results of the sequence of decisions, for each of multiple classes, a relevant class membership probability for the training sensor data element, and
ascertaining a loss of the class membership probability, ascertained for the training data element, in comparison to a ground truth for class membership of the sensor data training data element;
adjusting the machine learning model in order to reduce a total loss, which includes the losses ascertained for the sensor data training data elements, wherein the parameter vector for each decision of the machine learning model is adjusted within a continuous value range;
capturing sensor data relating to an environment of the robotic device;
classifying an object, represented by the sensor data, by classifying the sensor data using the trained machine learning model; and
controlling the robotic device according to the classification of the object.

14. A data processing device configured to train a machine learning model to classify sensor data, the data processing device configured to:
for each training sensor data element of a plurality of training sensor data elements:
represent the training sensor data element as an input vector,
process the input vector through a sequence of decisions of the machine learning model, wherein, for each decision, the scalar product of the input vector with a relevant parameter vector is formed and a result of the decision depends on whether the scalar product is less or greater than a specified relevant parameter,
ascertain, depending on the results of the sequence of decisions, for each of multiple classes, a relevant class membership probability for the training sensor data element, and
ascertain a loss of the class membership probability, ascertained for the training data element, in comparison to a ground truth for class membership of the sensor data training data element;
adjust the machine learning model in order to reduce a total loss, which includes the losses ascertained for the sensor data training data elements, wherein the parameter vector for each decision of the machine learning model is adjusted within a continuous value range.

15. A non-transitory computer-readable medium on which are stored commands for training a machine learning model to classify sensor data, the commands, when executed by a processor, causing the processor to perform the following steps:
for each training sensor data element of a plurality of training sensor data elements:
representing the training sensor data element as an input vector,
processing the input vector through a sequence of decisions of the machine learning model, wherein, for each decision, the scalar product of the input vector with a relevant parameter vector is formed and a result of the decision depends on whether the scalar product is less or greater than a specified relevant parameter,
ascertaining, depending on the results of the sequence of decisions, for each of multiple classes, a relevant class membership probability for the training sensor data element, and
ascertaining a loss of the class membership probability, ascertained for the training data element, in comparison to a ground truth for class membership of the sensor data training data element;
adjusting the machine learning model in order to reduce a total loss, which includes the losses ascertained for the sensor data training data elements, wherein the parameter vector for each decision of the machine learning model is adjusted within a continuous value range.
